(19) United States
(12) Patent Application Publication
(10) Pub. No.: US 2026/0084393 A1
(43) Pub. Date: Mar. 26, 2026

(54) PANEL FORMING APPARATUS AND PANEL FORMING METHOD USING THE SAME

(71) Applicant: SAMSUNG DISPLAY CO., LTD., YONGIN-SI (KR)

(72) Inventors: HONGCHUL SHIN, Yongin-si (KR); MINSEOK KANG, Yongin-si (KR)

(21) Appl. No.: 19/226,304

(22) Filed: Jun. 3, 2025

(30) Foreign Application Priority Data
Sep. 24, 2024 (KR) 10-2024-0129236

(51) Int. Cl. B30B 15/06; B30B 7/00

(52) U.S. Cl. CPC B30B 15/062; B30B 7/00

(57) ABSTRACT

A panel forming apparatus includes a first jig. A second jig is positioned adjacent to the first jig. The first jig includes a planarized part having a flat upper surface. A first edge part extends from the planarized part towards the second jig. The first edge part has an upper surface having a convex curved surface. The second jig includes a second edge part positioned adjacent to the first edge part. The second edge part has an upper surface having a convex curved surface.

### CROSS-REFERENCE TO RELATED APPLICATIONS

This application claims priority under 35 U.S.C. § 119 to Korean Patent Application No. 10-2024-0129236, filed on Sep. 24, 2024 in the Korean Intellectual Property Office, the disclosure of which is incorporated by reference in its entirety herein.

### 1. TECHNICAL FIELD

Embodiments of the present disclosure described herein relate to a panel forming apparatus and a panel forming method using the same.

### 2. DISCUSSION OF RELATED ART

Display devices have been applied to an increasing variety of electronic devices, such as smart phones, digital cameras, notebook computers, navigation systems, and smart televisions along with the advancement of the information society. The display device generate images and provide them to users of the electronic devices through display screens.

Recently, various types of display devices have been developed along with the development of display device technology. For example, display devices having curved surfaces have been developed. A display device having a curved surface includes a display panel that displays images. There is a demand for development of technologies for easily forming side surfaces of display panels into curved surfaces.

### SUMMARY

Embodiments of the present disclosure provide a panel forming apparatus that may form a side surface of a display panel into a curved surface easily, and a panel forming method using the same.

According to an embodiment, a panel forming apparatus includes a first jig. A second jig is positioned adjacent to the first jig. The first jig includes a planarized part having a flat upper surface. A first edge part extends from the planarized part towards the second jig. The first edge part has an upper surface having a convex curved surface. The second jig includes a second edge part positioned adjacent to the first edge part. The second edge part has an upper surface having a convex curved surface.

According to an embodiment, a panel forming method includes preparing a lower jig including a first jig including a planarized part having a flat upper surface and a first edge part extending further outward from the planarized part and a second jig including a second edge part positioned adjacent to the first edge part. A display panel is provided on the lower jig. An outermost edge part of the display panel that is disposed on the second edge part is pressed by moving an upper jig disposed on the display panel downward. An inner edge part of the display panel that is disposed on the first edge part is then pressed by further moving the upper jig downward. The first edge part and the second edge part have convex curved surfaces.

### BRIEF DESCRIPTION OF THE DRAWINGS

The above and other objects and features of the present disclosure will become apparent by describing in detail non-limiting embodiments thereof with reference to the accompanying drawings.

FIG. 1 is a perspective view of a panel forming apparatus according to an embodiment of the present disclosure.

FIG. 2 is an exploded perspective view of the panel forming apparatus illustrated in FIG. 1 according to an embodiment of the present disclosure.

FIG. 3 is a side view of the panel forming apparatus illustrated in FIG. 1, viewed from a second direction according to an embodiment of the present disclosure.

FIGS. 4 and 5 are cross-sectional views taken along line I-I′ illustrated in FIG. 1 according to embodiments of the present disclosure.

FIG. 6 is an enlarged view of a portion of a panel forming apparatus, which is adjacent to a vertical movement part disposed on a left side of the side view illustrated in FIG. 3 according to an embodiment of the present disclosure.

FIG. 7 is a cross-sectional view taken along line II-II′ illustrated in FIG. 1 according to an embodiment of the present disclosure.

FIG. 8 is a cross-sectional view taken along line III-III′ illustrated in FIG. 1 according to an embodiment of the present disclosure.

FIG. 9 is a perspective view of a display device including a display panel manufactured by using a panel forming apparatus according to an embodiment of the present disclosure.

FIG. 10 is a schematic cross-sectional view of a display module and a window of the display device illustrated in FIG. 9 according to an embodiment of the present disclosure.

FIG. 11 is a view illustrating a cross-section of the display module illustrated in FIG. 10 according to an embodiment of the present disclosure.

FIG. 12 is a view illustrating a cross-section of the display panel illustrated in FIG. 11 according to an embodiment of the present disclosure.

FIGS. 13A to 13D are views illustrating a panel forming method using the panel forming apparatus illustrated in FIG. 1 according to embodiments of the present disclosure.

FIGS. 14A to 14C are views illustrating a method for forming a display panel by using a jig of a panel forming apparatus according to a comparative embodiment.

FIG. 15 is a perspective view of a panel forming apparatus according to an embodiment of the present disclosure.

### DETAILED DESCRIPTION OF EMBODIMENTS

In the specification, when it is mentioned that a component (or an area, a layer, a part, or the like) is “disposed on”, “connected to”, or “coupled to” another component, it means that the former component may be directly disposed on, connected to, or coupled to the latter component or a third component may be disposed between the components. When a component is described as being “disposed directly on”, “connected directly to”, or “coupled directly to” another component, no intervening elements are present.

The same reference numerals denote the same components. Furthermore, in the drawings, thicknesses, ratios, dimensions of the components may be exaggerated for an effective description of the technical contents.

The term “and/or” includes one or more combinations that may be defined by the associated components.

Furthermore, in describing the various components, the terms, such as first and second may be used, but the present disclosure is not limited by the terms. The terms are simply for distinguishing the components. For example, a first component may be named a second component, and similarly the second component also may be named the first component while not departing from the scope of the present disclosure. A singular expression includes a plural expression unless an exemption is explicitly described in the context.

Furthermore, the terms, such as “under”, “below”, “on”, and “above”, are used to describe an associative relationship between the components illustrated in the drawings. The terms are relative concepts, and are described with respect to directions indicated in the drawings.

Unless otherwise defined, all terms, including technical and scientific terms, used herein have the same meaning as commonly understood by those skilled in the art to which the present disclosure pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

When the terms, such as “comprise” and/or “comprising”, is used in the specification, it should be understood that they specify presence of the above-mentioned features, numbers, steps, operations, components, parts, and/or combinations thereof, and do not exclude presence or addition of one or more other numbers, steps, operations, components, parts, and/or combinations thereof.

Hereinafter, embodiments of the present disclosure will be described with reference to the drawings.

The present disclosure concerns a panel forming apparatus that includes a first jig including a planarized part having a flat upper surface and a first edge part having an upper surface having a convex curved surface. A second jig includes a second edge part positioned adjacent to the first edge part and having a convex curved surface. When an upper surface of the first edge part is at a same height as the upper surface of the second edge part, an outer edge part of a display panel may be fixed by an upper jig and the second jig to decrease a degree of freedom of the edge part of the display panel. The upper jig may then be moved further downward while the degree of freedom of the edge part is reduced so that the first and second edge parts are disposed on a same curved surface. The inner edge part of the display panel between the outermost edge part and the planarized part may then be heated and formed to reduce the occurrence of wrinkles in the edge part of the display panel. Therefore, the panel forming apparatus produces panels with increased reliability.

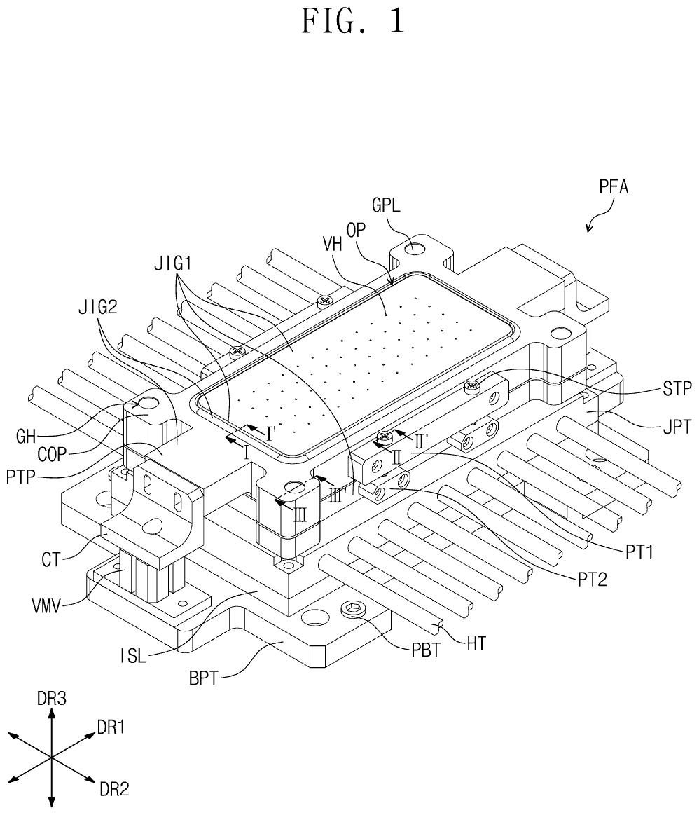

FIG. 1 is a perspective view of a panel forming apparatus according to an embodiment of the present disclosure.

Referring to FIG. 1, a panel forming apparatus PFA according to an embodiment of the present disclosure may include a first jig JIG1, a second jig JIG2, a plurality of guide pillars GPL, a plurality of first protrusions PT1, a plurality of second protrusions PT2, a plurality of stoppers STP, a plurality of coupling parts CT, a plurality of vertical movement parts VMV, a jig plate JPT, a plurality of heaters HT, an insulation layer ISL, a base plate BPT, and a plurality of planarization adjusting bolts PBT.

Hereinafter, in the specification, a first direction DR1, a second direction DR2 that crosses the first direction DR1, and a third direction DR3 that crosses substantially perpendicularly to a plane that is defined by the first direction DR1 and the second direction DR2 are defined. However, embodiments of the present disclosure are not necessarily limited thereto and the first to third directions DR1 to DR3 may cross each other at various different angles. In the specification, the meaning of “when viewed on a plane” may mean a state, in which it is viewed from the third direction DR3. The first direction DR1 or the second direction DR2 may be defined as a horizontal direction, and the third direction DR3 may be defined as a vertical direction.

In an embodiment, an upper surface of the first jig JIG1 may have a plane that is defined by the first and second directions DR1 and DR2. A plurality of vacuum suction holes VH may be defined in the upper surface of the first jig JIG1. When a process object is disposed on the upper surface of the first jig JIG1, the vacuum suction holes VH may be maintained in a vacuum state so that the process object may be suctioned to the upper surface of the first jig JIG1. Accordingly, the process object may be fixed to the upper surface of the first jig JIG1.

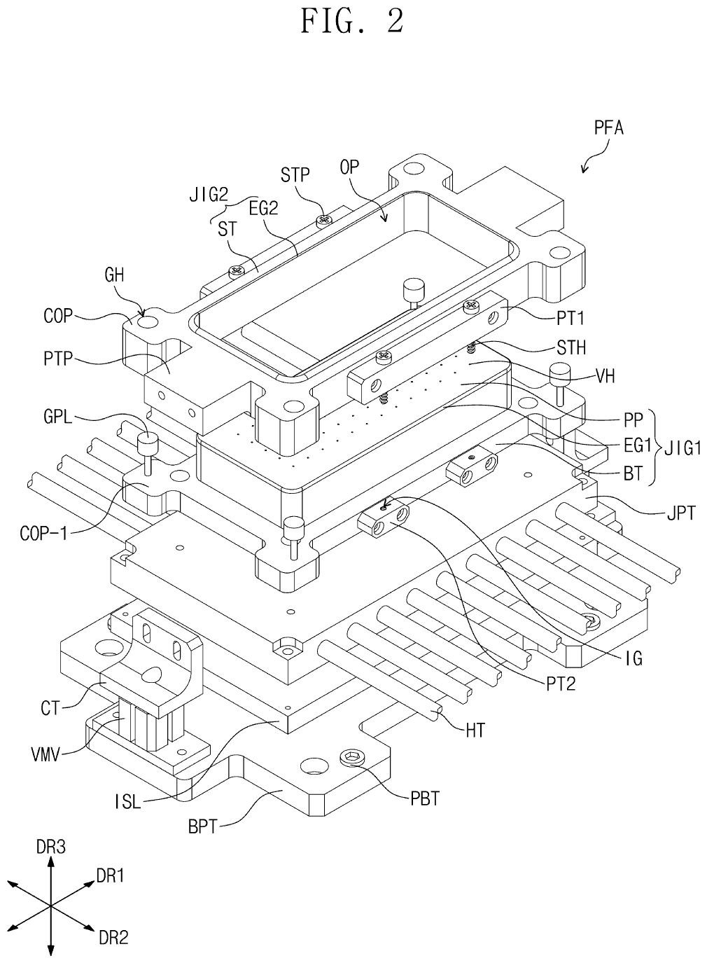

The second jig JIG2 may be adjacent to the first jig JIG1 (e.g., directly adjacent in the third direction DR3). An opening OP may be defined in the second jig JIG2, and the first jig JIG1 may be disposed in the opening OP. Accordingly, the second jig JIG2 may be disposed to surround the first jig JIG1 (e.g., in a plan view). A portion of the first jig JIG1 may extend to a lower side of the second jig JIG2 and may be disposed under the second jig JIG2. A detailed configuration of the first and second jigs JIG1 and JIG2 will be described in detail with reference to an exploded perspective view illustrated in FIG. 2.

The first and second jigs JIG1 and JIG2 may be defined as lower jigs. For example, in an embodiment the lower jigs may include the first jig JIG1 and the second jig JIG2. In an embodiment, the first and second jigs JIG1 and JIG2 may include a metal, such as aluminum or carbon steel.

Guide pillars GPL may be disposed adjacent to a periphery of the second jig JIG2. The guide pillars GPL may be disposed in guide holes GH that are defined in portions of the second jig JIG2, such as a portion of the seating part ST, which is adjacent to the periphery of the second jig JIG2, such as a periphery of the seating part ST. The guide pillars GPL may be defined as bushings. A detailed configuration of the guide pillars GPL will be described below in detail with reference to an exploded perspective view illustrated in FIG. 2.

Corners of the second jig JIG2 may have a shape that protrude outward, and the protruding portions may be defined as corner protrusions COP. The guide holes GH may be defined in the corner protrusions COP of the second jig JIG2.

In an embodiment, the first protrusions PT1 may be connected to (e.g., directly connected thereto) opposite side surfaces of the second jig JIG2, such as opposite side surfaces of the seating part ST, which are opposite to each other in the second direction DR2. The first protrusions PT1 may extend longer in the first direction DR1 than in the second direction DR2. In an embodiment, one first protrusion PT1 may be connected to each of the opposite side surfaces of the second jig JIG2.

The second protrusions PT2 may be connected to (e.g., directly connected thereto) opposite side surfaces of the first jig JIG1 disposed under the second jig JIG2. In an embodiment, the second protrusions PT2 may be connected to opposite side surfaces of the first jig JIG1, such as opposite side surfaces of the bottom part BT, which are opposite to each other in the second direction DR2. The second protrusions PT2 may extend longer in the first direction DR1 than in the second direction DR2. In an embodiment, two second protrusions PT2 may be connected to each of opposite side surfaces of the first jig JIG1 disposed under the second jig JIG2. However, embodiments of the present disclosure are not necessarily limited thereto and the number of the second protrusions PT2 may vary.

Although two second protrusions PT2 disposed on one side surface of the first jig JIG1 are illustrated on an observation position of the perspective view in FIG. 2, two second protrusions PT2 may also be disposed on an opposite side of the first jig JIG1.

On each of the opposite side surfaces of the first jig JIG1 disposed under the second jig JIG2 and each of the opposite side surfaces of the second jig JIG2, the second protrusions PT2 may be disposed to overlap the first protrusions PT1, when viewed on a plane. For example, in an embodiment two second protrusions PT2 may overlap one first protrusions PT1. However, the numbers of the first and second protrusions PT1 and PT2 are not necessarily limited thereto.

The stoppers STP may be connected to the first protrusions PT1. In an embodiment, the stoppers STP connected to the first protrusions PT1 may extend in the third direction DR3, and may be connected to the second protrusions PT2, respectively to couple the first jig JIG1 and the second jig JIG2 to each other. Threads STH of a male screw may be defined on an outer peripheral surface under the stoppers STP. The number of stoppers STP may be the same as the number of second protrusions PT2.

The coupling parts CT may be connected to opposite side surfaces of the second jig JIG2, which are opposite to each other in the first direction DR1. Protrusions PTP may be formed on portions of opposite side surfaces of the second jig JIG2, which are opposite to each other in the first direction DR1. The coupling parts CT may be connected to the protrusions PTP, respectively.

The vertical movement parts VMV may be disposed under the coupling parts CT, respectively. The vertical movement parts VMV may be connected to (e.g., directly connected thereto) the coupling parts CT, respectively. The coupling parts CT may be coupled to move in the third direction DR3 with respect to the vertical movement parts VMV. The coupling parts CT may reciprocate in the third direction DR3 by the vertical movement parts VMV.

The vertical movement parts VMV may be connected to the second jig JIG2 through the coupling parts CT. When the vertical movement parts VMV move the coupling parts CT in the third direction DR3, the second jig JIG2 connected to the coupling parts CT may be moved in the third direction DR3. Accordingly, the vertical movement parts VMV may move the second jig JIG2 in the third direction DR3. In an embodiment, the vertical movement parts VMV may be implemented in a cylindrical shape. However, embodiments of the present disclosure are not necessarily limited thereto.

The jig plate JPT may be disposed under the first and second jigs JIG1 and JIG2 (e.g., in a direction opposite to the third direction DR3). The jig plate JPT may be connected to the first and second jigs JIG1 and JIG2. The jig plate JPT may support the first and second jigs JIG1 and JIG2.

The heaters HT may be connected to opposite side surfaces of the jig plate JPT, which are opposite to each other in the second direction DR2. In an embodiment, the heaters HT may extend longitudinally in the second direction DR2. In an embodiment, the heaters HT may be implemented as cartridge type heaters. However, embodiments of the present disclosure are not necessarily limited thereto.

The jig plate JPT may be heated by the heaters HT, and heat may be applied to the first and second jigs JIG1 and JIG2 through the jig plate JPT. Accordingly, the first and second jigs JIG1 and JIG2 may be heated by the heaters HT. In an operation of forming the display panel that will be described below, the display panel may be heated by the first and second jigs JIG1 and JIG2 to form the display panel.

The insulation layer ISL and the base plate BPT may be disposed under the jig plate JPT (e.g., in a direction opposite to the third direction DR3). The base plate BPT may be disposed under the insulation layer ISL (e.g., in a direction opposite to the third direction DR3). The insulation layer ISL may be connected to the jig plate JPT. The insulation layer ISL may perform an insulation function. In an embodiment, the insulation layer ISL may be disposed between the jig plate JPT and the base plate BPT (e.g. in the third direction DR3) to block heat of the jig plate JPT from being applied to the base plate BPT.

The base plate BPT may be connected to (e.g., directly connected thereto) the insulation layer ISL. The base plate BPT may support the insulation layer ISL, the jig plate JPT, and the first and second jigs JIG1 and JIG2.

When viewed on a plane, the base plate BPT may extend further on an outer side than the insulation layer ISL, the jig plate JPT, and the first and second jigs JIG1 and JIG2. The vertical movement parts VMV may be connected to an upper surface of the base plate BPT, which are adjacent to opposite sides of the base plate BPT, which are opposite to each other in the first direction DR1. The vertical movement parts VMV may be disposed further on an outer side than the insulation layer ISL, the jig plate JPT, and the first and second jigs JIG1 and JIG2 and may be connected to the base plate BPT.

The planarization adjusting bolts PBT may be connected to the base plate BPT adjacent to a periphery of the base plate BPT. In an embodiment, the planarization adjusting bolts PBT may be connected to four points of the base plate BPT, which are adjacent to the periphery of the base plate BPT. The planarization adjusting bolts PBT may be rotated to adjust the heights of the four points of the base plate BPT. According to the operation, a flatness of the base plate BPT may be adjusted by rotating the adjusting bolts PBT.

FIG. 2 is an exploded perspective view of the panel forming apparatus illustrated in FIG. 1.

Referring to embodiments shown in FIGS. 1 and 2, the first jig JIG1, the second jig JIG2, the jig plate JPT, the insulation layer ISL, and the base plate BPT may extend longer in the second direction DR2 than in the first direction DR1.

In an embodiment, the first jig JIG1 may include a planarized part PP, a first edge part EG1, and a bottom part BT. The planarized part PP may have a flat upper surface. For example, in an embodiment the planarized part PP may have an upper surface that is defined by the first and second directions DR1 and DR2. Vacuum suction holes VH may be defined in the planarized part PP.

The first edge part EG1 may extend from the planarized part PP towards the second jig JIG2. The first edge part EG1 may surround the planarized part PP (e.g., in a plan view). In an embodiment, the first edge part EG1 may have an upper surface having a convex curved surface. For example, an upper surface of the first edge part EG1 may have a curved surface that extends to an outer lower side from the planarized part PP.

A bottom part BT may be connected to a lower portion of the planarized part PP and a lower portion of the first edge part EG1, and may extend further to an outer side than the first edge part EG1 when viewed on a plane. In an embodiment, the bottom part BT may extend further to an outer side than the first edge part EG1 in the horizontal direction (e.g., the first direction DR1 and the second direction DR2). In an embodiment, the bottom part BT may extend longer in the first direction DR1 than the second direction DR2. In an embodiment, the bottom part BT, the planarized part PP, and the first edge part EG1 may be integrally formed with each other.

In an embodiment, the bottom part BT has a shape corresponding to a rectangular shape, and the rectangular corners of the bottom part BT may protrude outwardly to define the corner protrusions COP-1. The bottom part BT has long sides that extend in the first direction DR1 and short sides that extend in the second direction DR2, and the corner protrusions COP-1 may protrude further to an outer side than the long sides and short sides. The long sides and the short sides of the bottom part BT and the peripheries of the corner protrusions COP-1 may be connected to each other to define the peripheries of the bottom part BT.

The guide pillars GPL may be connected to (e.g., directly connected thereto) a portion of an upper surface of a bottom part BT, which is adjacent to a periphery of the bottom part BT, and may extend upward (e.g., in the third direction DR3). For example, in an embodiment the guide pillars GPL may be connected to (e.g., directly connected thereto) the corner protrusions COP-1 of the bottom part BT. The guide pillars GPL may have a cylindrical shape that extend in the third direction DR3. A diameter of an upper portion of each of the guide pillars GPL may be greater than a diameter of a lower portion of each of the guide pillars GPL.

The second protrusions PT2 may be connected to one side and an opposite side of the bottom part BT, which are opposite to each other in the second direction DR2. An insertion groove IG may be defined in an upper surface of each of the second protrusions PT2 for receiving the stoppers STP.

In an embodiment, the second jig JIG2 may include a second edge part EG2 and a seating part ST. The second edge part EG2 may surround the first edge part EG1. The second edge part EG2 may be disposed adjacent to the first edge part EG1, and may have an upper surface having a convex curved surface. An upper surface of the second edge part EG2 may have a curved surface that extends to an outer lower side.

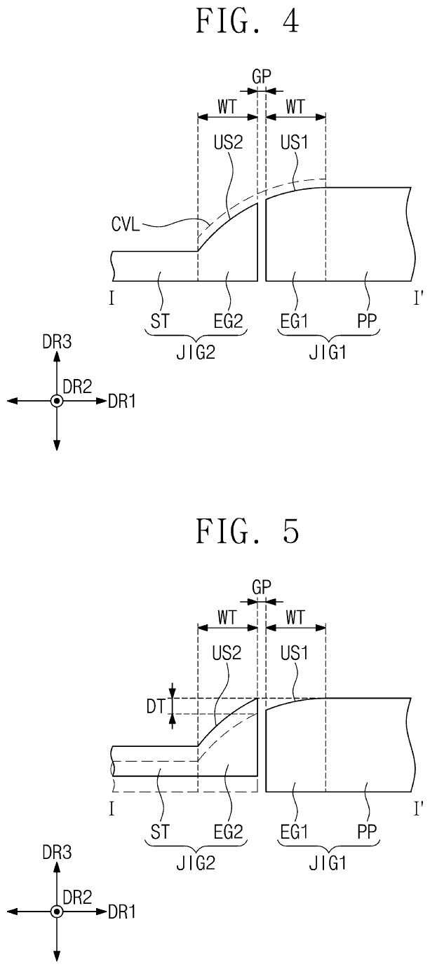

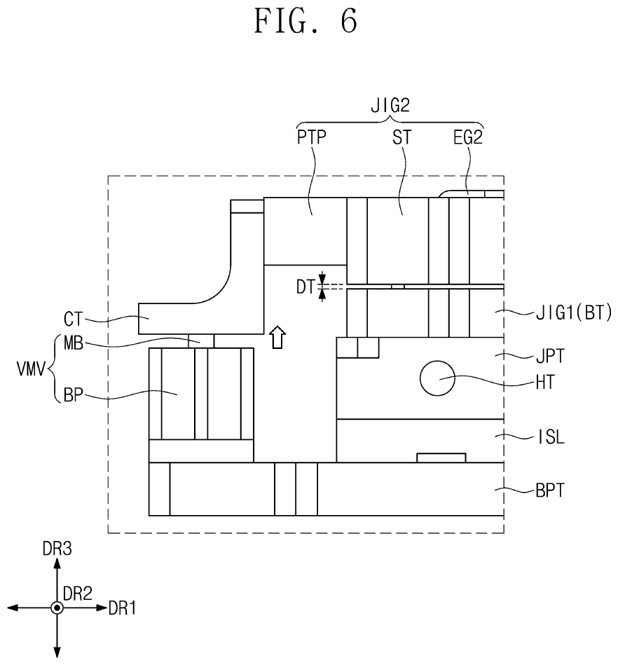

In an embodiment, an upper end of the second edge part EG2 and an upper end of the first edge part EG1 may be disposed at the same height (e.g., coplanar in the third direction DR3). The configuration will be described in detail with reference to FIGS. 4 and 5.

The seating part ST may be connected to (e.g., directly connected thereto) a periphery of the second edge part EG2, and may extend further to an outer side than the second edge part EG2 when viewed on a plane. In an embodiment, the second edge part EG2 and the seating part ST may be integrally formed with each other. The second edge part EG2 may have a flat upper surface that is defined by (e.g., extends in) the first and second directions DR1 and DR2. The seating part ST may be disposed on the bottom part BT (e.g., disposed directly thereon in the third direction DR3).

In an embodiment, the seating part ST has a shape corresponding to a rectangular shape, and the rectangular corners of the seating part ST may protrude outward to define the corner protrusions COP. When viewed on a plane, the corner protrusions COP of the seating part ST may overlap the corner protrusions COP-1 of the bottom part BT (e.g., in the third direction DR3). The corner protrusions COP may have substantially the same shape as the corner protrusions COP-1.

Portions of the opposite side surfaces of the seating part ST, which are opposite to each other in the first direction DR1, may protrude to an outside to define the protrusions PTP. A portion of the seating part ST that does not include the protrusions PTP, may substantially have a shape corresponding to the bottom part BT of the first jig JIG1.

The guide pillars GPL may be disposed in the guide holes GH defined in the seating part ST adjacent to the periphery of the seating part ST, respectively. The guide holes GH may be defined in the corner protrusions COP of the seating part ST.

The first protrusions PT1 may be connected to (e.g., directly connected thereto) one side surface and an opposite side surface of the seating part ST, which are opposite to each other in the second direction DR2.

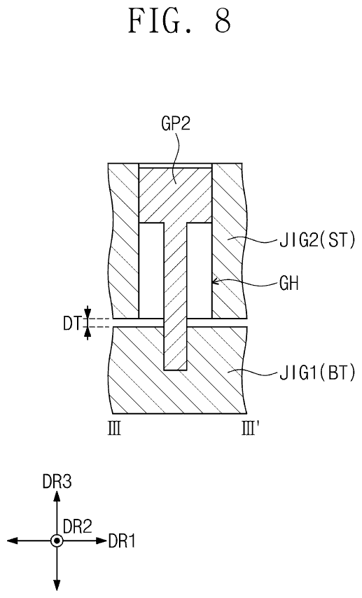

The stoppers STP may be disposed on the first protrusions PT1 to be connected to the first protrusions PT1, and may extend to a lower side than the first protrusions PT1. The stoppers STP may be disposed on the movement holes MV defined in the first protrusions PT1 to extend downward, and this configuration will be described in detail below with reference to FIG. 7.

Lower portions of the stoppers STP may be connected to (e.g., directly connected thereto) the second protrusions PT2. For example, lower portions of the stoppers STP may be inserted into insertion grooves IG defined in the second protrusions PT2. This configuration will also be described in detail with reference to FIG. 7.

In an embodiment, the jig plate JPT, the insulation layer ISL, and the base plate BPT may have a flat plate shape that is defined by (e.g., extends in) the first and second directions DR1 and DR2.

In an embodiment of the present disclosure, the first jig JIG1, the second jig JIG2, the jig plate JPT, the insulation layer ISL, the base plate BPT, the coupling part CT, the vertical movement parts VMV, the first protrusions PT1, and the second protrusions PT2 may be coupled to each other by pins having a bolt shape. However, embodiments of the present disclosure are not necessarily limited thereto and the coupling means of the components may vary.

Furthermore, holes and grooves for disposing the pins may be defined in various positions of the first jig JIG1, the second jig JIG2, the jig plate JPT, the insulation layer ISL, the base plate BPT, the coupling part CT, the vertical movement parts VMV, the first protrusions PT1, and the second protrusions PT2.

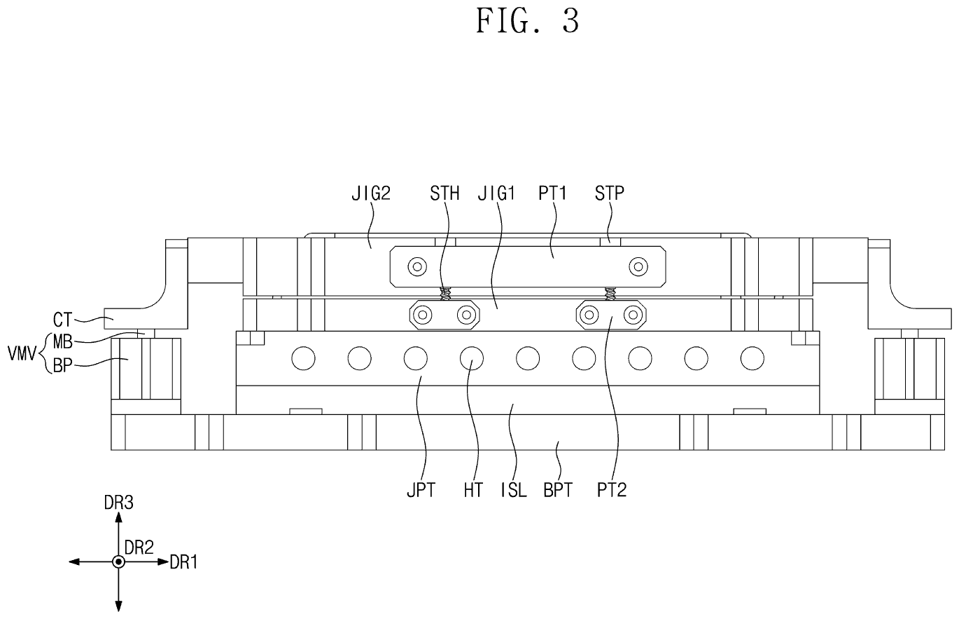

FIG. 3 is a side view of the panel forming apparatus illustrated in FIG. 1, viewed from a second direction.

Referring to FIG. 3, in an embodiment each of the vertical movement parts VMV may include a body part BP that is connected to the base plate BPT and a movement bar MB that is connected to the body part BP. In an embodiment, movement bars MB may extend longitudinally in the third direction DR3, and may extend onto the body parts BP.

The coupling parts CT may be disposed on the body parts BP, respectively. The movement bars MB may be connected to (e.g., directly connected thereto) the coupling parts CT, respectively.

In an embodiment, the movement bars MB may be coupled to be fixed to the coupling parts CT, and may be coupled to be moved in the third direction DR3 with respect to the body parts BP. As the movement bars MB are moved in the third direction DR3, the coupling parts CT may be moved in the third direction DR3, and as the coupling parts CT are moved in the third direction DR3, the second jig JIG2 may be moved in the third direction DR3.

FIGS. 4 and 5 are cross-sectional views taken along line I-I′ illustrated in FIG. 1.

A disposition state of the first and second edge parts EG1 and EG2 illustrated in FIG. 5 corresponds to the disposition state of the first and second edge parts EG1 and EG2 illustrated in FIG. 1, and FIG. 4 may be defined as an initial disposition state of the first and second edge parts EG1 and EG2. By way of example, portions of the first and second jigs JIG1 and JIG2 are illustrated in FIGS. 4 and 5, and configurations disposed under the first and second jigs JIG1 and JIG2 are omitted.

Referring to FIG. 4, an upper surface US1 of the first edge part EG1 may have a convex curved surface that extends to an outer lower side from a flat upper surface of the planarized part PP. An upper surface US2 of the second edge part EG2 may have a convex curved surface that extends towards an outer lower side.

In an initial mode, the upper surface US2 of the second edge part EG2 may be disposed lower than an upper surface US1 of the first edge part EG1. In the initial mode, the upper surface US1 of the first edge part EG1 and the upper surface US2 of the second edge part EG2 may be disposed on a same curved surface CVL. For example, the curved surface CVL is illustrated by using a dotted line in FIG. 4.

Referring to FIG. 5, in a process mode for performing a forming process, the second edge part EG2 may be move upward in the third direction DR3. The coupling parts CT and the second jig JIG2 may be moved upward by the vertical movement parts VMV described above, and the second edge part EG2 may be moved upward.

The second edge part EG2 may be moved upward by a specific distance DT more than in the initial mode. A height of an upper end of the second edge part EG2 may be increased by the specific distance DT as compared to the initial mode. In an embodiment, a position of the second jig JIG2 in the initial mode is illustrated by using a dotted line in FIG. 5.

As the second edge part EG2 is moved upward, the height of the upper end of the second edge part EG2 may be the same as the height of the upper end of the first edge part EG1. The height of the upper end of the first edge part EG1 may be defined as the height of the upper surface of the planarized part PP.

Referring to FIGS. 4 and 5, a width WT of the first edge part EG1 and a width WT of the second edge part EG2 may be the same (e.g., equal to each other) in the first direction DR1 that is a horizontal direction parallel to the flat upper surface of the planarized part PP. The first edge part EG1 and the second edge part EG2 may be spaced apart from each other by a specific interval GP in the first direction DR1. In an embodiment, the interval GP between the first edge part EG1 and the second edge part EG2 may be in a range of about 100 micrometers (μm) to about 200 micrometers (μm).

In a comparative embodiment in which the second edge part EG2 directly contacts with the first edge part EG1, frictions may occur on contact surfaces between the second edge part EG2 and the first edge part EG1 as the second edge part EG2 is moved in the third direction DR3. The second edge part EG2 and the first edge part EG1 may be damaged by the frictions. To prevent damage caused by the frictions, the first edge part EG1 and the second edge part EG2 may be disposed to be spaced apart from each other by the specific interval GP.

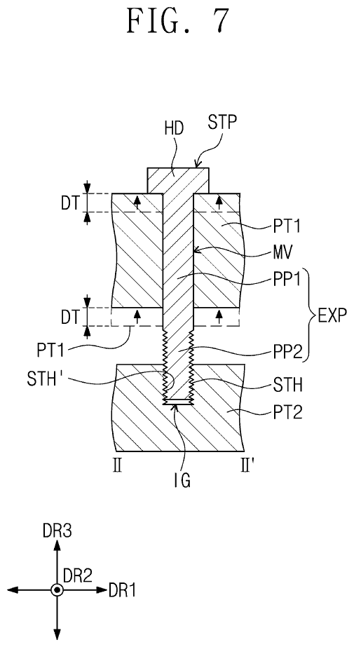

FIG. 6 is an enlarged view of a portion of a panel forming apparatus, which is adjacent to a vertical movement part disposed on a left side of the side view illustrated in FIG. 3.

Referring to FIG. 6, the coupling part CT may be moved upward by a movement bar MB of the vertical movement part VMV, and the second jig JIG2 connected to the coupling part CT may be moved upward. The second jig JIG2 may be moved upward by the specific distance DT. The second jig JIG2 may be moved upward by the specific distance DT by the vertical movement part VMV.

In the initial mode, the seating part ST of the second jig JIG2 may directly contact a bottom part BT of the first jig JIG1, and in a process mode, the seating part ST of the second jig JIG2 may be moved upward (e.g., in the third direction DR3) by the specific distance DT from the bottom part BT of the first jig JIG1.

FIG. 7 is a cross-sectional view taken along line II-II′ illustrated in FIG. 1.

By way of example, in FIG. 7, configurations disposed under a second protrusion PT2 are omitted.

Referring to FIG. 7, in an embodiment the stopper STP may include a head part HD and an extension EXP. A movement hole MV that extends in the third direction DR3 may be defined in the first protrusion PT1.

The head part HD may be disposed on the first protrusion PT1. When viewed on a plane, the head part HD may have a larger area than that of the movement hole MV.

The extension EXP may extend downward from the head part HD. In an embodiment, the extension EXP may have a cylindrical shape that extends in the third direction DR3. The extension EXP may be disposed in the movement hole MV, and may extend downward to be connected to (e.g., directly connected thereto) the second protrusion PT2.

The extension EXP may include a first part PP1 that extends downward from the head part HD (e.g., in a direction opposite to the third direction DR3) and a second part PP2 that extends downward from the first part PP1. The first part PP1 may be disposed in the movement hole MV so that the stopper STP may be connected to the first protrusion PT1. The first protrusion PT1 may be moved along the first part PP1.

The second part PP2 may be connected to (e.g., directly connected thereto) the second protrusion PT2. In an embodiment, a thread STH of a male screw may be defined on an outer peripheral surface of the second part PP2. For example, the second part PP2 may be defined in the form of a male screw. The second part PP2 may be inserted into an insertion groove IG, and the stopper STP may be connected to (e.g., directly connected thereto) the second protrusion PT2.

In an embodiment, a thread STH′ of a female screw may be defined on an inner surface of the second protrusion PT2, on which the insertion groove IG is defined. For example, the inner surface of the second protrusion PT2, on which the insertion groove IG is defined, may be defined as a female screw. The second part PP2 may be rotated and inserted into the insertion groove IG to be connected to (e.g., directly connected thereto) the second protrusion PT2.

In the initial mode, a position of the first protrusion PT1 is illustrated by using a dotted line, and in the process mode, the position of the first protrusion PT1 is illustrated by using a solid line.

Referring to embodiments shown in FIGS. 4 and 7, in the initial mode, the seating part ST of the second jig JIG2 may directly contact an upper surface of the bottom part BT of the first jig JIG1. In this embodiment, the first protrusion PT1 connected to the seating part ST of the second jig JIG2 may be spaced downward apart from the head part HD of the stopper STP. For example, in the initial mode, the first protrusion PT1 may not directly contact the head part HD. The first protrusion PT1 and the head part HD may be spaced apart from each other by the specific distance DT in the third direction DR3.

Referring to FIGS. 5 and 7, in the process mode, the second jig JIG2 may be moved upward. The first protrusion PT1 connected to the seating part ST of the second jig JIG2 may also be moved upward. The position of the second protrusion PT2 connected to the bottom part BT of the first jig JIG1 may be fixed. Accordingly, the stopper STP may be in a fixed state when the first protrusion PT1 is moved upward.

The first protrusion PT1 may be moved upward and may directly contact the head part HD to stop the movement. The first protrusion PT1 may be moved upward by the specific distance DT to stop the movement. Accordingly, the second edge part EG2 may be moved upward by the specific distance DT in the process mode as compared to in the initial mode. The distance DT may be defined as a movement distance DT of the second jig JIG2.

The stopper STP may limit the movement distance with respect to the upward direction of the first protrusion PT1. Accordingly, the movement distance with respect to the upward direction of the second jig JIG2 connected to the first protrusion PT1 may be limited by the stopper STP. The movement distance with respect to the upward direction of the second edge part EG2 of the second jig JIG2 may be limited to the specific distance DT by the stopper STP.

The movement distance DT of the second jig JIG2 may be set variously. As the stopper STP is rotated with respect to the second protrusion PT2, a height of the head part HD of the stopper STP may be varied (e.g., changes when rotated). For example, in an embodiment when the stopper STP is rotated clockwise to further fasten the second part PP2 to the second protrusion PT2, the height of the head part HD may become smaller. On the contrary, when the stopper STP is rotated counterclockwise to partially displace the second part PP2 from the second protrusion PT2, the height of the head part HD may become larger.

In an embodiment, the height of the head part HD may be adjusted according to the rotation of the stopper STP. By adjusting the height of the head part HD, the movement distance DT of the second jig JIG2 may be variously adjusted.

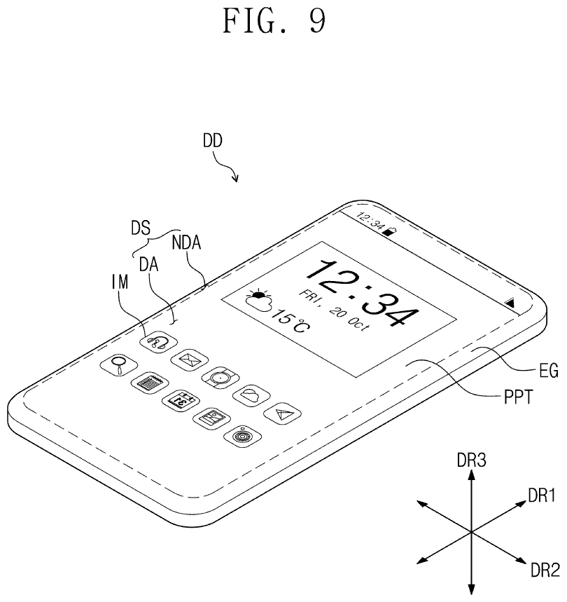

FIG. 8 is a cross-sectional view taken along line III-III′ illustrated in FIG. 1.

Referring to FIG. 8, a guide pillar GPL may be disposed in a guide hole GH. When the second jig JIG2 is moved in the third direction DR3, the second jig JIG2 may be moved along the guide pillar GPL.

Referring to FIGS. 1 and 8, since the guide pillars GPL are disposed at four points, the second jig JIG2 may be disposed in a regular position without being distorted by the guide pillars GPL. For example, the second jig JIG2 may maintain a level orientation as it is moved in the third direction DR3 along the guide pillar GPL. The guide pillars GPL may have a function of guiding the position of the second jig JIG2.

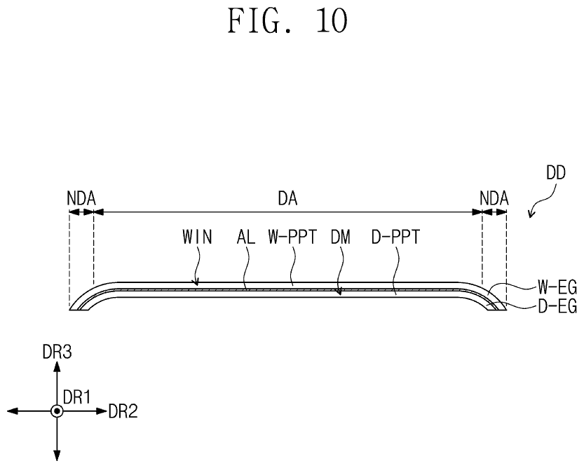

FIG. 9 is a perspective view of a display device including a display panel manufactured by using a panel forming apparatus according to an embodiment of the present disclosure.

Referring to FIG. 9, a display device DD according to an embodiment of the present disclosure may have long sides that extend parallel to each other in the first direction DR1, and short sides that extend parallel to each other in the second direction DR2. In an embodiment, corners of the display device DD that connect the long sides and the short sides of the display device DD to each other may have a curved shape. The corners of the display device DD having a curved shape may be defined as round corners. The shape of the display device DD (e.g., in a plan view) may be defined as a round corner rectangular shape.

Images IM that are generated by the display device DD may be provided to a user through the upper surface of the display device DD viewed from the third direction DR3. The upper surface of the display device DD may include a display area DA, and a non-display area NDA around the display area DA (e.g., in a plan view). The display area DA may display an image, and the non-display area NDA may not display an image. In an embodiment, the non-display area NDA may surround the display area DA and define a periphery of the display device DD printed in a specific color.

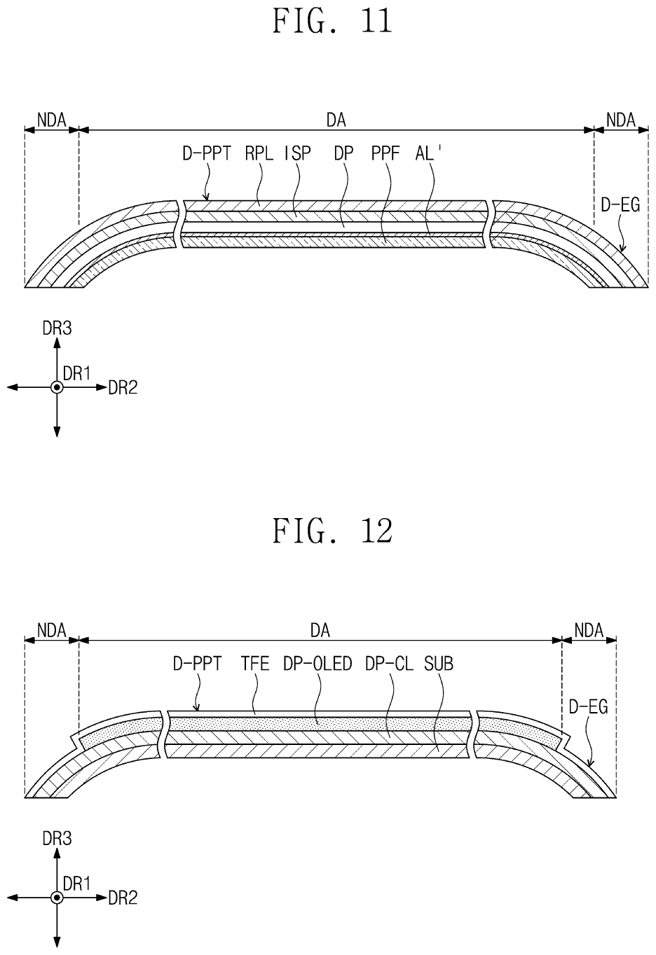

In an embodiment, the upper surface of the display device DD may include a flat planar part PPT and an edge part EG having a curved surface. The planar part PPT may have a plane that is defined by (e.g., extends in) the first and second directions DR1 and DR2. The edge part EG may surround the planar part PPT (e.g., in a plan view). The edge part EG may extend to an outer lower side from the planar part PPT to form a curved surface. The edge part EG may have a specific curvature. The display area DA may be defined in the planar part PPT and a portion of the edge part EG, which is adjacent to the planar part PPT (hereinafter, will be more clearly illustrated in FIGS. 10 to 12).

Although the display device DD is illustrated as a mobile phone, embodiments of the present disclosure are not necessarily limited thereto, and the display device DD may be used in various electronic devices. For example, the display device DD may be used in large electronic devices, such as televisions, monitors, or external billboards. Furthermore, the display device DD may be used in small and medium-sized electronic devices, such as personal computers, laptop computers, car navigation, game consoles, tablets, or cameras.

FIG. 10 is a schematic cross-sectional view of a display module and a window of the display device illustrated in FIG. 9.

An embodiment shown in FIG. 10 illustrates cross-sections of a display module DM and a window WIN, viewed from the first direction DR1.

Referring to FIG. 10, in an embodiment the display device DD may include a display module DM, and a window WIN that is disposed on the display module DM. The window WIN may protect the display module DM from external scratches and impacts.

The display module DM may include a flat planar part D-PPT, and an edge part D-EG that extends from sides of the planar part D-PPT to have a curved surface. In an embodiment, the window WIN may include a flat planar part W-PPT, and an edge part W-EG that extends from sides of the planar part W-PPT to have a curved surface.

When viewed on a plane, the planar part D-PPT of the display module DM and the planar part W-PPT of the window WIN may overlap each other. When viewed on a plane, the edge part D-EG of the display module DM and the edge part W-EG of the window WIN may overlap each other.

The planar part D-PPT of the display module DM and the planar part W-PPT of the window WIN may correspond to the planar part PPT of the display device DD. The edge part D-EG of the display module DM and the edge part W-EG of the window WIN may correspond to the edge part EG of the display device DD.

In an embodiment, the display module DM and the window WIN may have shapes corresponding to the display device DD illustrated in FIG. 9. For example, the display module DM and the window WIN may have a round corner rectangular shape corresponding to the display device DD.

In an embodiment, an adhesion layer AL may be disposed between (e.g., disposed directly therebetween) the display module DM and the window WIN. The display module DM and the window WIN may be combined with each other by the adhesion layer AL. In an embodiment, the adhesion layer AL may include a pressure sensitive adhesive (PSA) or an optically clear adhesive (OCA). However, embodiments of the present disclosure are not necessarily limited thereto and the type of the adhesive may vary.

The display area DA may be defined in a planar part PPT and a portion of the edge part EG, which is adjacent to the planar part PPT. Accordingly, the portion of the edge part EG, which is adjacent to the planar part PPT, may display an image.

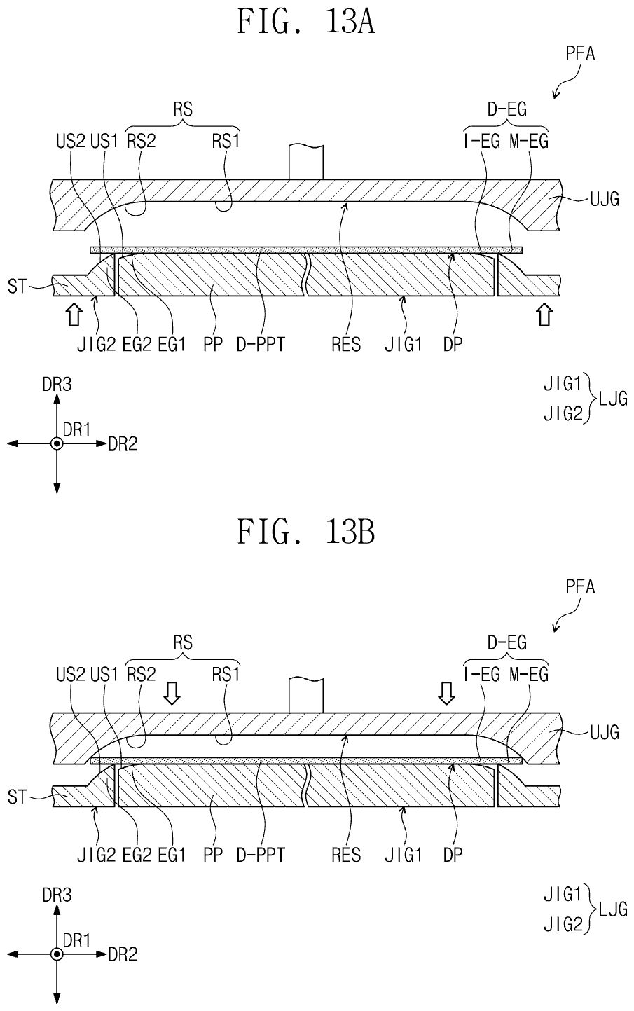

FIG. 11 is a view illustrating a cross section of the display module illustrated in FIG. 10 according to an embodiment of the present disclosure.

FIG. 11 illustrates a cross section of the display module DM viewed from the first direction DR1 according to an embodiment of the present disclosure.

Referring to FIG. 11, in an embodiment the display module DM may include a display panel DP, an input sensing part ISP, a reflection prevention layer RPL, a panel protective film PPF, and an adhesion layer AL′.

The display panel DP according to an embodiment of the present disclosure may be a light emitting display panel. In an embodiment, the display panel DP may be an organic light emitting display panel or an inorganic light emitting display panel. A light emitting layer of the organic light emitting display panel may include an organic light emitting material. A light emitting layer of the inorganic light emitting display panel may include a quantum dot, a quantum rod, and the like. Hereinafter, the display panel DP is described as an organic light emitting display panel.

The input sensing part ISP may be disposed on (e.g., disposed directly thereon) the display panel DP. In an embodiment, the input sensing part ISP may include a plurality of sensing units for sensing an external input in a capacitive manner. The input sensing part ISP may be manufactured directly on the display panel DP when the display device DD is manufactured. However, embodiments of the present disclosure are not necessarily limited thereto. For example, in some embodiments the input sensing part ISP may be manufactured as a separate panel from the display panel DP and may be attached to the display panel DP by an adhesion layer.

The reflection prevention layer RPL may be disposed on (e.g., disposed directly thereon) the input sensing part ISP. In an embodiment, when the display device DD is manufactured, the reflection prevention layer RPL may be manufactured directly on the input sensing part ISP. However, embodiments of the present disclosure are not necessarily limited thereto. For example, in some embodiments the reflection prevention layer RPL may be manufactured as a separate panel, and may be attached to the input sensing part ISP by the adhesion layer.

The reflection prevention layer RPL may be defined as an external light prevention film. The reflection prevention layer RPL may reduce a reflectance of external light that is input from the display device DD towards the display panel DP. The external light may not be visually recognized by the user due to the reflection prevention layer RPL.

When the external light that has traveled towards the display panel DP is reflected from the display panel DP and is provided again to an external user, like a mirror, the user may visually recognize the external light. To prevent this phenomenon, in an embodiment, the reflection prevention layer RPL may include a plurality of color filters that display the same color as that of the pixels of the display panel DP.

In an embodiment, the color filters may filter external light having the same color as that of the pixels. In this embodiment, the external light may not be visually recognized by the user. However, embodiments of the present disclosure are not necessarily limited thereto, and the reflection prevention layer RPL may include a retarder and/or a polarizer to reduce the reflectance of the external light.

The panel protective film PPF may be disposed under the display panel DP. The panel protective film PPF may protect a lower portion of the display panel DP. In an embodiment, the panel protective film PPF may include a flexible plastic material, such as polyethylene terephthalate (PET).

The adhesion layer AL′ may be disposed between (e.g., disposed directly therebetween) the display panel DP and the panel protective film PPF. The display panel DP and the panel protective film PPF may be combined with each other by the adhesion layer AL′. In an embodiment, the adhesion layer AL′ may include a pressure-sensitive adhesive or an optical transparent adhesive. However, embodiments of the present disclosure are not necessarily limited thereto and the type of the adhesive may vary.

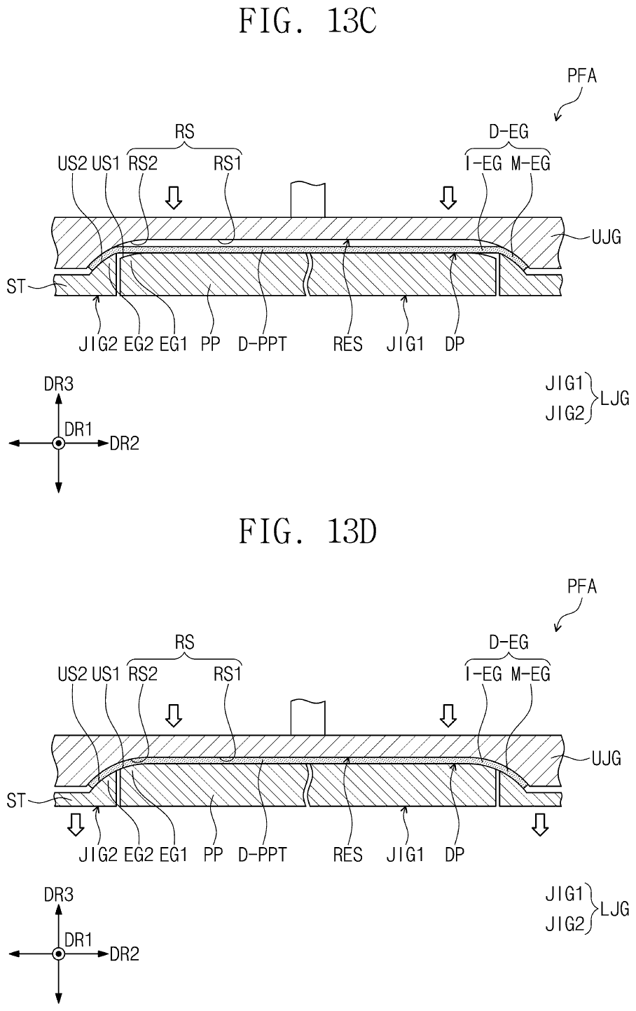

FIG. 12 is a view illustrating a cross section of the display panel illustrated in FIG. 11 in an embodiment.

FIG. 12 illustrates a cross-section of the display panel DP viewed from the first direction DR1 according to an embodiment of the present disclosure.

Referring to FIG. 12, in an embodiment the display panel DP may include a substrate SUB, a circuit element layer DP-CL that is disposed on the substrate SUB, a display element layer DP-OLED that is disposed on the circuit element layer DP-CL, and a thin film encapsulation layer TFE that is disposed on the display element layer DP-OLED.

The display panel DP may include a flat planar part D-PPT, and an edge part D-EG that extends from the planar part D-PPT to have a curved surface. In the present specification, the planar part D-PPT and the edge part D-EG of the display panel DP are denoted by the same reference numerals as those of the planar part D-PPT and the edge part D-EG of the display module DM.

In an embodiment, the substrate SUB may include a display area DA and a non-display area NDA around the display area DA (e.g., in a plan view). In an embodiment, the substrate SUB may include glass or may include a flexible plastic material such as polyimide (PI).

The display element layer DP-OLED may be disposed on the display area DA. The display element layer DP-OLED may generate an image. In an embodiment, the display element layer DP-OLED may be disposed in the planar part D-PPT and a portion of an edge part D-EG, which is adjacent to the planar part D-PPT. Accordingly, the image may be displayed at a portion of the edge part D-EG, which is adjacent to the planar part D-PPT.

A plurality of pixels may be disposed in the circuit element layer DP-CL and the display element layer DP-OLED. In an embodiment, each of the pixels may include a transistor that is disposed in the circuit element layer DP-CL and a light emitting element that is disposed in the display element layer DP-OLED and is connected to the transistor.

The thin film encapsulation layer TFE may be disposed on the circuit element layer DP-CL to cover the display element layer DP-OLED. The thin film encapsulation layer TFE may protect the pixels from moisture, oxygen, and external foreign substances.

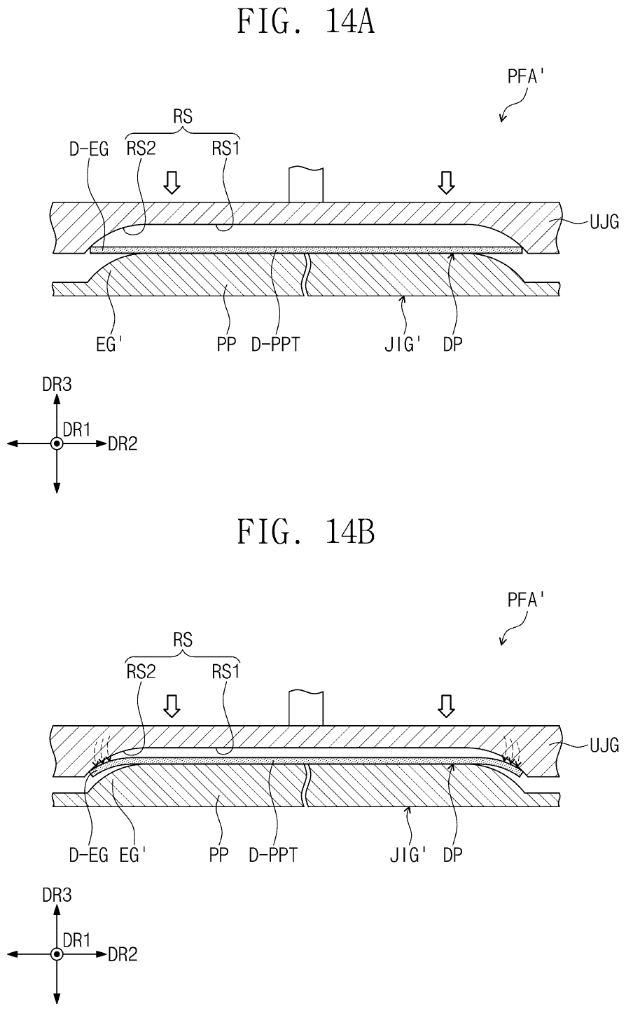

FIGS. 13A to 13D are views illustrating a panel forming method using the panel forming apparatus illustrated in FIG. 1.

In FIGS. 13A to 13D, upper components of the first and second jigs JIG1 and JIG2, which are components for directly forming the display panel DP while contacting the display panel DP are illustrated, and other components of the panel forming apparatus PFA are omitted. The omitted components of the panel forming apparatus PFA are illustrated in FIGS. 1 and 2. FIGS. 13A to 13D are illustrated with cross-sections viewed in the first direction DR1 according to embodiments of the present disclosure.

Referring to FIG. 13A, a lower jig LJG including a first jig JIG1 and a second jig JIG2 may be prepared, and a display panel DP in a flat state may be provided on the lower jig LJG. First, the first edge part EG1 and the second edge part EG2 are arranged as in the initial mode illustrated in FIG. 4, and then, as illustrated in FIG. 13a, in a process mode, before the display panel DP is pressed, the first edge part EG1 may be moved upward by the vertical movement parts VMV described above, such that an upper end of the first edge part EG1 and an upper end of the second edge part EG2 may be disposed at the same height as each other.

In an embodiment, the panel forming apparatus PFA may include an upper jig UJG that is disposed on the first and second jigs JIG1 and JIG2. The upper jig UJG may be disposed on the display panel DP. A recessed part RES may be defined on a lower surface of the upper jig UJG, which faces the lower jig LJG.

The recessed surface RS of the upper jig, on which the recessed part RES is defined, may include a first recessed surface RS1 and a second recessed surface RS2. The first recessed surface RS1 may have a plane corresponding to the planarized part PP. For example, the first recessed surface RS1 may overlap the planarized part PP to face the planarized part PP (e.g., in the third direction DR3).

The second recessed surface RS2 may have a concave shape corresponding to the curved surfaces when the curved surfaces of the first and second upper surfaces US1 and US2 of the first and second edge parts EG1 and EG2 illustrated in FIG. 4 are aligned to be disposed on the same curved surface CVL in the initial mode.

The display panel DP may be disposed on the first and second jigs JIG1 and JIG2. Since the edge part D-EG of the display panel DP has not yet been molded, the edge part D-EG may initially be in a flat state. The planar part D-PPT of the display panel DP may be disposed on the planarized part PP of the first jig JIG1. The planar part D-PPT may be suctioned and fixed to the upper surface of the planarized part PP by the vacuum induction holes VH described above.

In an embodiment, the edge part D-EG may include an outermost edge part M-EG that overlaps the second edge part EG2 of the second jig JIG2 (e.g., in the third direction DR3) and an inner edge part I-EG that overlaps the first edge part EG1 of the first jig JIG1. An outermost edge part M-EG may be disposed on the second edge part EG2, and the inner edge part I-EG may be disposed on the first edge part EG1. The inner edge part I-EG may be disposed between the outermost edge part M-EG and the planar part D-PPT (e.g., in the second direction DR2).

Vacuum suction holes VH are not defined in the first and second edge parts EG1 and EG2. The edge part D-EG may not be fixed to the first and second edge parts EG1 and EG2. Accordingly, a degree of freedom of the edge part D-EG may be higher than that of the planarized part PP. The degree of freedom may be defined to an extent that it is not fixed.

The heat of the heaters HT described above may be applied to the first and second jigs JIG1 and JIG2, and the heat may be applied to the display panel DP by the heated first and second jigs JIG1 and JIG2. The heat may be applied to the display panel DP to form the display panel DP.

Referring to FIG. 13B, an upper jig UJG may be moved downward. The upper jig UJG may be moved downward, and the second recessed surface RS2 may first directly contact a periphery of an outermost edge part M-EG.

Referring to FIG. 13C, the upper jig UJG may be moved further downward to press the outermost edge part M-EG disposed on the second edge part EG2. The second recessed surface RS2 may directly contact the outermost edge part M-EG to press the outermost edge part M-EG. The outermost edge part M-EG may be pressed between the second edge part EG2 and the second recessed surface RS2 to be formed into a curved surface.

The outermost edge part M-EG may be fixed between the second edge part EG2 and the first recessed surface RS1. Accordingly, a degree of freedom of the edge part D-EG of the display panel DP may be decreased.

Referring to FIG. 13D, while the outermost edge part M-EG is fixed between the second edge part EG2 and the second recessed surface RS2, the upper jig UJG may be moved further downward. When the upper jig UJG is moved downward, the vertical movement parts VMV may also move downward, and the second jig JIG2 connected to the coupling parts CT may be moved downward together with the upper jig UJG.

The second jig JIG2 may be moved downward, and the second edge part EG2 and the first edge part EG1 may be disposed on the same curved surface CVL, as illustrated in FIG. 4. The upper jig UJG may be moved downward to press the inner edge part I-EG disposed on the first edge part EG1.

The second recessed surface RS2 may directly contact the inner edge part I-EG to press the inner edge part I-EG. The inner edge part I-EG may be pressed between the first edge part EG1 and the second recessed surface RS2 to be formed into a curved surface. Accordingly, the edge part EG of the display panel DP may be formed to have a curved surface by the first and second edge parts EG1 and EG2.

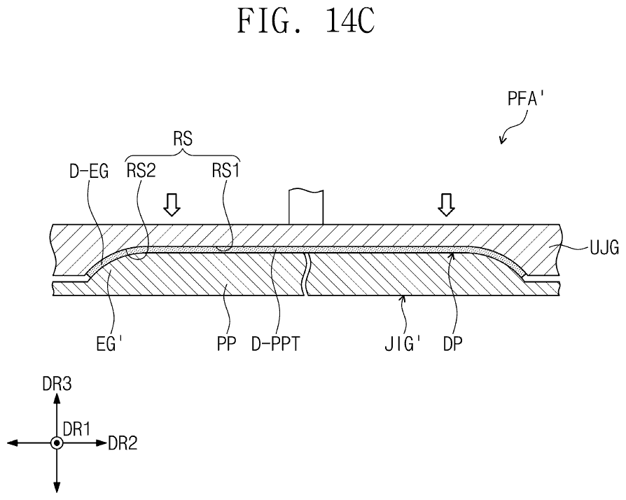

FIGS. 14A to 14C are views illustrating a method for forming a display panel by using a jig of a panel forming apparatus according to a comparative embodiment.

FIGS. 14A to 14C are illustrated in cross sections corresponding to FIGS. 13A to 13D.

Referring to FIG. 14A, unlike the panel forming apparatus PFA according to an embodiment of the present disclosure, the panel forming apparatus PFA′ may include a single jig JIG′. The jig JIG′ may include a planarized part PP and an edge part EG′ that extends outward from sides of the planarized part PP. An upper surface of the edge part EG′ may have a curved surface. The upper jig UJG may be moved downward to directly contact a periphery of the edge part D-EG of the display panel DP.

Referring to FIGS. 14B and 14C, the upper jig UJG may be moved further downward to press the edge part D-EG of the display panel DP, which is disposed on the edge part EG′ of the jig JIG′. The edge part D-EG may be pressed while gradually directly contacting the upper surface of the edge part EG′ from a portion of the edge part D-EG, which is adjacent to the planar part D-PPT. Accordingly, the edge part D-EG may be heated and formed gradually towards the periphery of the display panel DP from the edge part D-EG that is adjacent to the planar part D-PPT.

As described above, since only the planar part D-PPT is fixed and the edge part D-EG is not fixed, the degree of freedom of the edge part D-EG may be high. In this comparative embodiment, when the edge part D-EG is formed from the edge part D-EG that is adjacent to the planar part D-PPT towards the periphery of the display panel DP, a degree of expansion of the edge part D-EG having a high degree of freedom may become gradually higher as it goes toward the periphery of the display panel DP. Accordingly, wrinkles may occur in the edge part D-EG.

In an embodiment of the present disclosure, the outermost edge part M-EG of the display panel DP may be first formed by the second jig JIG2, and the outermost edge part M-EG may be fixed by the upper jig UJG and the second jig JIG2. Accordingly, a degree of freedom of the edge part D-EG of the display panel DP may be decreased.

Thereafter, while the degree of freedom is decreased, the inner edge part I-EG between the fixed outermost edge part M-EG and the fixed planar part D-PPT may be heated and folded. In this embodiment, a probability of occurrence of wrinkles in the edge part D-EG of the display panel DP may be decreased. As a result, defects in the edge part D-EG may be decreased.

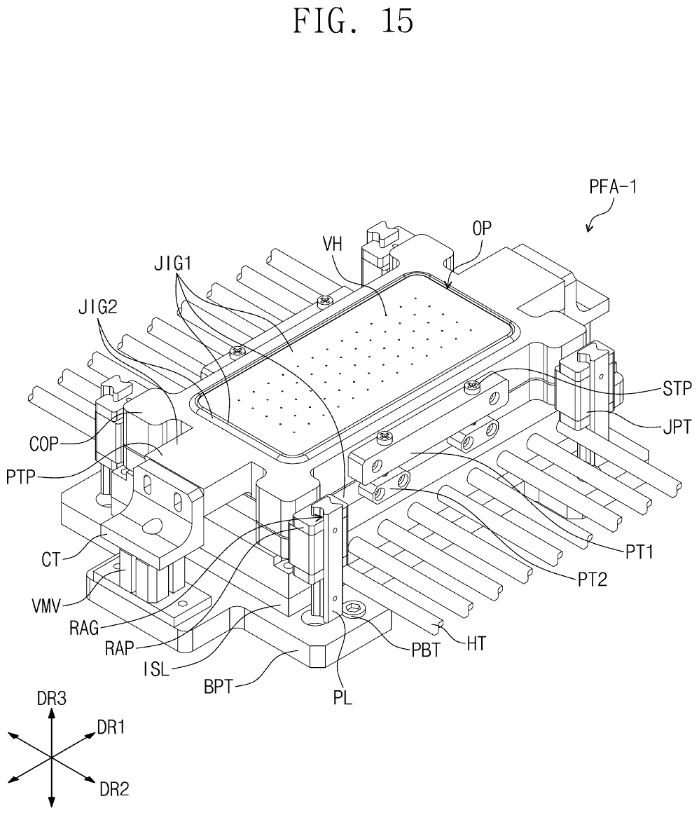

FIG. 15 is a perspective view of a panel forming apparatus according to another embodiment of the present disclosure.

Hereinafter, the configuration of the panel forming apparatus PFA-1 illustrated in FIG. 15 will be described mainly based on the panel forming apparatus PFA illustrated in FIG. 1 and other components.

Referring to FIG. 15, the panel forming apparatus PFA-1 may include a plurality of rail parts RAP and a plurality of pillars PL. The rail parts RAP may extend in the third direction DR3 and may be connected to the seating part ST of the second jig JIG2. The pillars PL may extend in the third direction DR3 and may be connected to the base plate BPT.

The rail parts RAP may be connected to the side surfaces of the corner protrusions COP. Rail grooves RAG may be defined in the rail parts RAP. The pillars PL may be disposed on the rail grooves RAG. When the second jig JIG2 moves in the third direction DR3, the rail parts RAP connected to the second jig JIG2 may be moved in the third direction DR3 along the pillars PL connected to the base plate BPT. Substantially, instead of the guide pillars GPL described above, the rail parts RAP and the pillars PL may be used to guide the position of the second jig JIG2.

According to an embodiment of the present disclosure, the outermost edge part of the display panel is first formed by the second jig disposed on an outer side of the first jig, and the outermost edge part may be fixed by the upper jig and the second jig. Accordingly, the degree of freedom of the edge part of the display panel may be decreased. Thereafter, with the degree of freedom of the edge part decreased, the inner edge part of the display panel between the outermost edge part and the planarized part may be heated and formed. In this case, the probability of occurrence of wrinkles in the edge part may be decreased. Accordingly, the defects in the edge part may be decreased.

Although the present disclosure has been described with reference to non-limiting embodiments, it will be appreciated by an ordinary skilled in the art, to which the present disclosure pertains, that the present disclosure may be modified and changed within the scope of the present disclosure. Therefore, the technical scope of embodiments of the present disclosure should not be limited to embodiments described in the detailed description of the specification.

What is claimed is:

1. A panel forming apparatus comprising:
a first jig; and
a second jig positioned adjacent to the first jig,
wherein the first jig includes:
a planarized part having a flat upper surface; and
a first edge part extending from the planarized part towards the second jig, the first edge part having an upper surface having a convex curved surface,
wherein the second jig includes a second edge part positioned adjacent to the first edge part, the second edge part having an upper surface having a convex curved surface.

2. The panel forming apparatus of claim 1, wherein a width of the first edge part and a width of the second edge part in a direction parallel to the flat upper surface are equal to each other.

3. The panel forming apparatus of claim 2, wherein the first edge part and the second edge part are spaced apart from each other in the direction parallel to the flat upper surface.

4. The panel forming apparatus of claim 3, wherein an interval between the first edge part and the second edge part is in a range of about 100 micrometers to about 200 micrometers.

5. The panel forming apparatus of claim 1, wherein:
a height of an upper end of the second edge part is equal to a height of an upper end of the first edge part;
the upper surface of the first edge part has a convex curved surface extending towards an outer lower side; and
the upper surface of the second edge part has a convex curved surface extending towards the outer lower side.

6. The panel forming apparatus of claim 1, further comprising:
an upper jig disposed on the first jig and the second jig,
wherein the upper jig includes a recessed part recessed upwardly defined in a lower surface of the upper jig.

7. The panel forming apparatus of claim 6, wherein:
the recessed part is defined in a recessed surface, the recessed surface includes:
a first recessed surface having a flat surface corresponding to the planarized part; and
a second recessed surface having a concave shape corresponding to curved surfaces of the upper surfaces of the first edge part and the second edge part when the upper surfaces of the first edge part and the second edge part are aligned to be disposed on a same curved surface.

8. The panel forming apparatus of claim 1, wherein:
an opening is defined in the second jig;
the first jig is disposed in the opening; and
the second jig surrounds the first jig disposed in the opening.

9. The panel forming apparatus of claim 1, wherein:
the first jig further includes a bottom part connected to lower portions of the planarized part and the first edge part, and when viewed on a plane, the bottom part extends further to an outer side than the first edge part;
the second jig further includes a seating part that, when viewed on the plane, is connected to a periphery of the second edge part and extends further to an outer side than the second edge part, and
the seating part is disposed on the bottom part.

10. The panel forming apparatus of claim 9, further comprising:
a guide pillar connected to a portion of an upper surface of the bottom part that is adjacent to a periphery of the bottom part and extending upwardly; and
the guide pillar is disposed in a guide hole defined in a portion of the seating part adjacent to a periphery of the seating part.

11. The panel forming apparatus of claim 9, further comprising:
a first protrusion connected to one side surface of the seating part;
a second protrusion that, when viewed on the plane, overlaps the first protrusion, and is connected to one side surface of the bottom part; and
a stopper connected to the first protrusion and the second protrusion, the stopper is disposed in a movement hole defined in the first protrusion.

12. The panel forming apparatus of claim 11, wherein the stopper includes:
a head part that, when viewed on the plane, has a larger area than an area of the movement hole, and is disposed on the first protrusion;
a first part extending downwardly from the head part, and disposed in the movement hole; and
a second part extending downward from the first part, and connected to the second protrusion, and
wherein a thread of a male screw is defined on an outer peripheral surface of the second part, and the second part is rotated to be connected to the second protrusion.

13. The panel forming apparatus of claim 12, wherein a height of the head part changes according to rotation of the stopper.

14. The panel forming apparatus of claim 1, further comprising:
a vertical movement part connected to the second jig, the vertical movement part moving the second jig in a vertical direction.

15. The panel forming apparatus of claim 14, further comprising:
a jig plate disposed under the first jig and the second jig;
a heater connected to one side surface of the jig plate; and
a base plate disposed under the jig plate,
wherein the vertical movement part is connected to a portion of an upper surface of the base plate that is adjacent to one side of the base plate.

16. A panel forming method comprising:
preparing a lower jig including a first jig including a planarized part having a flat upper surface and a first edge part extending further outward from the planarized part and a second jig including a second edge part positioned adjacent to the first edge part;
providing a display panel on the lower jig;
pressing an outermost edge part of the display panel that is disposed on the second edge part, by moving an upper jig disposed on the display panel downward; and
pressing an inner edge part of the display panel that is disposed on the first edge part, by further moving the upper jig downward,
wherein the first edge part and the second edge part have convex curved surfaces.

17. The panel forming method of claim 16, wherein an edge part of the display panel including the outermost edge part and the inner edge part are formed to have a curved surface by the first edge part and the second edge part.

18. The panel forming method of claim 16, wherein:
before the display panel is pressed, a height of an upper end of the second edge part is equal to a height of an upper end of the first edge part; and
when the upper jig is moved downward, the second edge part is moved downward together with the upper jig.

19. The panel forming method of claim 16, wherein a width of the first edge part and a width of the second edge part in a direction parallel to the flat upper surface are equal to each other.

20. The panel forming method of claim 19, wherein the first edge part and the second edge part are spaced apart from each other in the direction parallel to the flat upper surface.
